(19) United States
(12) Patent Application Publication
(10) Pub. No.: US 2011/0235230 A1
(43) Pub. Date: Sep. 29, 2011

(54) TOUCH SCREEN

(76) Inventors: Jong Young LEE, Gyunggi-do (KR); Yong Soo OH, Gyunggi-do (KR)

(21) Appl. No.: 12/787,312

(22) Filed: May 25, 2010

(30) Foreign Application Priority Data
Mar. 29, 2010 (KR) 10-2010-0028063

(51) Int. Cl. H05F 3/00

(52) U.S. Cl. 361/212

(57) ABSTRACT

Disclosed is a touch screen, which includes a first transparent substrate having a first transparent electrode formed on one surface thereof, a second transparent substrate formed to face the first transparent substrate and having a second transparent electrode formed on one surface thereof, a first adhesive layer formed at an outer periphery between one surface of the first transparent substrate and one surface of the second transparent substrate, and an antistatic layer formed on the other surface of the first transparent substrate so that a touch input is applied thereto and including a conductive material, and in which the antistatic layer is formed on the upper surface of the first transparent substrate thus preventing the generation of static electricity and preventing damage to the first transparent substrate.

### CROSS REFERENCE TO RELATED APPLICATION

This application claims the benefit of Korean Patent Application No. 10-2010-0028063, filed Mar. 29, 2010, entitled “Touch screen”, which is hereby incorporated by reference in its entirety into this application.

### BACKGROUND OF THE INVENTION

1. Technical Field

The present invention relates to a touch screen.

2. Description of the Related Art

The continuous growth of electronics technology requires personal computers, portable transmitters and so on which process text and graphics using a variety of input devices such as a keyboard, mouse, digitizer, etc. However, because such input devices are developed depending on various needs of personal computers, it is problematic to apply them to portable devices that are riding the recent trend of having a reduced size and thickness. Accordingly, a touch screen is receiving attention as input means adapted for the portable device.

The touch screen is typically mounted on a display device so that a user selects the desired information, and is advantageous because it is simple, infrequently operates erroneously, enables space to be saved, and is easy to link with IT devices. Thanks to such advantages, the touch screen is widely utilized in various fields including industry, traffic, service, medical treatment, mobile, etc.

Now, a touch screen is generally classified as being of a resistive, capacitive, electromagnetic, SAW, or infrared type. In the case of a resistive touch screen, attempts are being made to remove the static electricity caused by friction when the outermost layer of the touch screen is touched by the body of a user.

FIG. 1 is a cross-sectional view showing a conventional resistive touch screen 10. With reference to this drawing, the conventional touch screen 10 is described below.

As shown in FIG. 1, the conventional touch screen 10 includes a transparent substrate 11, transparent electrodes 12, electrodes 13, and an adhesive layer 14.

The transparent substrate 11 is composed of two sheets, and the transparent electrodes 12 are respectively formed on the surfaces of two sheets of the transparent substrate 11. The electrodes 13 are used to apply voltage to the transparent electrodes 12, and are formed on the surfaces of two sheets of the transparent substrate 11 so as to be connected to the transparent electrodes 12. The adhesive layer 14 is formed at the outer periphery between the two sheets of the transparent substrate 11, so that two sheets of the transparent substrate 11 are adhered to each other. Further, dot spacers 15 are formed inside between the two sheets of the transparent substrate 11.

However, the conventional touch screen 10 is problematic because friction when the touch screen is touched by a specific object such as the body of a user or a stylus pen frequently creates static electricity on the upper surface of the transparent substrate 11, thus attaching impurities such as dust to the transparent substrate 11. Hence, the transparency of the touch screen 10 is undesirably decreased.

Furthermore, when the transparent substrate 11 is touched again by the body of the user or the like in a state in which impurities have become attached thereto, damage, such as scratches, to the transparent substrate 11 may undesirably occur.

### SUMMARY OF THE INVENTION

Accordingly, the present invention has been made keeping in mind the problems encountered in the related art and the present invention is intended to provide a touch screen which prevents the generation of static electricity on a transparent substrate at an outermost layer thereof.

Also the present invention is intended to provide a touch screen which prevents damage to a transparent substrate that is touched by the body of a user or the like.

An aspect of the present invention provides a touch screen, including a first transparent substrate having a first transparent electrode formed on one surface thereof, a second transparent substrate formed to face the first transparent substrate and having a second transparent electrode formed on one surface thereof, a first adhesive layer formed at an outer periphery between one surface of the first transparent substrate and one surface of the second transparent substrate, and an antistatic layer formed on the other surface of the first transparent substrate so that a touch input is applied thereto and including a conductive material.

In this aspect, the conductive material may be sodium alkylphosphate, conductive carbon black, carbon nanotubes, or a conductive polymer.

In this aspect, the antistatic layer may further include a surfactant.

In this aspect, the antistatic layer may have a sheet resistance of 10⁴˜10¹⁰Ω/□.

In this aspect, the touch screen may further include a spacer formed inside between one surface of the first transparent substrate and one surface of the second transparent substrate.

In this aspect, the touch screen may further include a display adhered to the other surface of the second transparent substrate by means of a second adhesive layer.

In this aspect, the second adhesive layer may be double-sided adhesive tape (DAT) formed at the outer periphery of the display.

Alternatively, the second adhesive layer may be an optical clear adhesive (OCA) formed on the entire surface of the display.

As such, the second adhesive layer may be silicone, polyurethane, PVC, acryl, or a mixture thereof.

In this aspect, the touch screen may further include a first electrode formed on one surface of the first transparent substrate and connected to the first transparent electrode so as to apply voltage, and a second electrode formed on one surface of the second transparent substrate and connected to the second transparent electrode so as to apply voltage.

### BRIEF DESCRIPTION OF THE DRAWINGS

The features and advantages of the present invention will be more clearly understood from the following detailed description taken in conjunction with the accompanying drawings, in which:

FIG. 1 is a cross-sectional view showing a conventional resistive touch screen;

FIG. 2 is a cross-sectional view showing a touch screen according to a first embodiment of the present invention; and

FIG. 3 is a cross-sectional view showing a touch screen according to a second embodiment of the present invention.

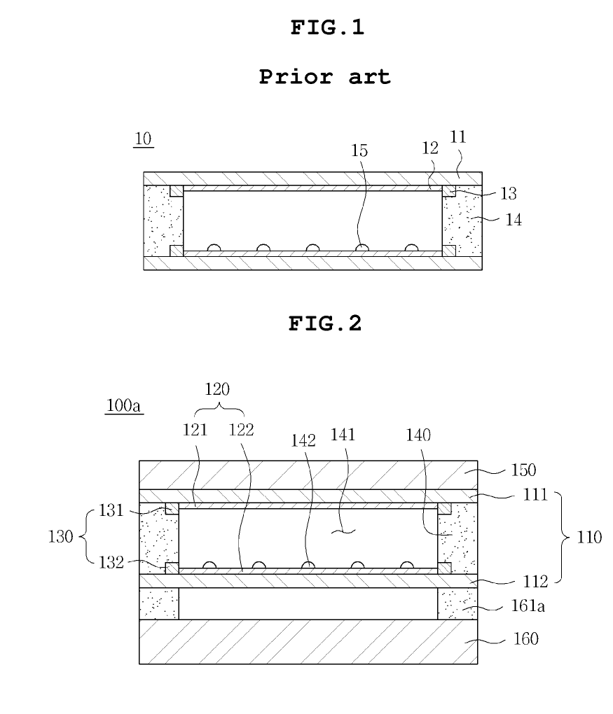

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second” and so on are used to distinguish one element from another element, and the elements are not defined by the above terms. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

FIG. 2 is a cross-sectional view showing a touch screen 100a according to a first embodiment of the present invention. With reference to this drawing, the touch screen 100a according to the present embodiment is described below.

As shown in FIG. 2, the touch screen 100a according to the present embodiment includes a transparent substrate 110, transparent electrodes 120, electrodes 130, a first adhesive layer 140, an antistatic layer 150, a second adhesive layer 161a, and a display 160.

The transparent substrate 110 includes a first transparent substrate 111 and a second transparent substrate 112.

The first transparent substrate 111 is a member to which pressure is applied from a specific object such as the body of a user or a stylus pen, and a first transparent electrode 121 is formed on one surface of the first transparent substrate 111. Also, because the first transparent substrate 111 is bent upon application of pressure and is then returned to its original position upon elimination of pressure, it should be made of an elastic material. For example, the first transparent substrate 111 may be provided in the form of a film using a transparent and elastic material, such as polyethyleneterephthalate (PET), polycarbonate (PC), polymethylmethacrylate (PMMA), polyethylenenaphthalate (PEN), polyethersulfone (PES) or cyclic olefin copolymer (COC). In addition, glass or reinforced glass which is typically used may be utilized. Additionally, it is possible to form a window plate (not shown) on the upper surface of the first transparent substrate 111 in order to protect the touch screen 100a.

The second transparent substrate 112 is disposed to face the first transparent substrate 111, and a second transparent electrode 122 is formed on one surface of the second transparent substrate 112. The second transparent substrate 112 may be made of the same transparent material as in the first transparent substrate 111, but need not be imparted with elasticity as in the first transparent substrate 111.

The transparent electrodes 120 are respectively formed on the first and second transparent substrates of the transparent substrate 110, and one surface of each of the first and second transparent substrates of the transparent substrate 110 may be subjected to high frequency treatment or primer treatment in order to enhance the adhesion thereof to the transparent electrodes 120.

The transparent electrodes 120 are respectively formed on the first and second transparent substrates of the transparent substrate 110 and thus come into contact with each other so as to recognize signals.

The transparent electrodes 120 may include the first transparent electrode 121 and the second transparent electrode 122. The first transparent electrode 121 and the second transparent electrode 122 may be respectively formed on the first transparent substrate 111 and the second transparent substrate 112 so as to face each other. The first transparent electrode 121 comes into contact with the second transparent electrode 122 due to pressure applied to the first transparent substrate 111, thus generating changes in voltage. Based thereon, a controller (not shown) recognizes the coordinates of the pressed position, thus realizing the desired operation.

The first transparent electrode 121 and the second transparent electrode 122 may be provided in the form of a bar shape so that they are disposed perpendicular to each other to recognize the coordinates of X axis and Y axis, respectively, but the present invention is not limited thereto. In addition, any shape, such as a lozenge, hexagon, octagon, triangle, etc., may be applied.

The transparent electrodes 120 are formed of a transparent material so that a user sees the display 160 which is disposed at the lower portion of the touch screen, and may be made of a conductive material. For example, the transparent electrodes 120 may be formed of a metal oxide such as indium tin oxide (ITO), or a conductive polymer composed of one or more selected from among poly-3,4-ethylenedioxythiophene/polystyrenesulfonate (PEDOT/PSS) and polyaniline As such, in the case where the transparent electrodes 120 are made of a metal oxide, they may be applied on the transparent substrate 110 using deposition, development and etching. On the other hand, in the case where the transparent electrodes 120 are made of a conductive polymer, they may be formed on the transparent substrate 110 using silk screen printing, ink jet printing, gravure printing, offset printing, etc.

The electrodes 130 are electrically connected to the transparent electrodes 120 so as to supply voltage to the transparent electrodes 120.

The electrodes 130 include a first electrode 131 and a second electrode 132. The first electrode 131 and the second electrode 132 may be formed on one surface of the first transparent substrate 111 and one surface of the second transparent substrate 112 so as to be connected to the first transparent electrode 121 and the second transparent electrode 122, respectively. Also, the electrodes 130 may be made of a material having high electrical conductivity so that voltage is supplied to the transparent electrodes 120. For example, the electrodes 130 may be made of silver (Ag) paste or organic Ag. Furthermore, because the electrodes 130 are formed at the outer to periphery of the transparent substrate 110, they need not be essentially made of a transparent material.

The first adhesive layer 140 is formed at the outer periphery between the surfaces of the first and second transparent substrates of the transparent substrate 110 having the transparent electrodes 120 formed thereon, and spacers 142 may be formed inside between the first and second transparent substrates of the transparent substrate 110.

The first adhesive layer 140, for example, double-sided adhesive tape (DAT), may be used to adhere the first transparent substrate 111 and the second transparent substrate 112 to each other. Furthermore, the first adhesive layer 140 is formed at the outer periphery between the first and second transparent substrates of the transparent substrate 110 so that the first transparent electrode 121 and the second transparent electrode 122 come into contact with each other between the first and second transparent substrates of the transparent substrate 110 when external pressure is applied. Thus, an empty space 141 may be defined by the first adhesive layer 140.

In this case, spacers 142 may be formed inside between the first and second transparent substrates of the transparent substrate 110, that is, in the empty space 141. For example, the spacers 142 may be provided in the form of dot spacers, and function to alleviate impact when the first transparent electrode 121 and the second transparent electrode 122 come into contact with each other, and function to supply repulsive force so that the first transparent substrate 111 is returned to its original position when pressure is eliminated. Also, the spacers 142 may usually perform the function of maintaining the insulation between the transparent electrodes 120 so as not to bring the first transparent electrode 121 into contact with the second transparent electrode 122 in the absence of external pressure.

The antistatic layer 150 is formed on the other surface of the first transparent substrate 111 which corresponds to the surface to which a touch input is applied as a result of direct touch by a specific object such as the body of a user or the like.

The antistatic layer 150 includes a conductive material and functions to remove static electricity and prevent impurities such as dust from remaining on the first transparent substrate 111. Specifically, static electricity is generated by separation of the electric double layer formed at the surface of contact of two objects. In the case where the antistatic layer 150 is formed, the separation of the electric double layer may be blocked by the conductive material.

Thus, the antistatic layer 150 may be made of a conductive material. For example, the antistatic layer 150 may include, as the conductive material, sodium alkylphosphate, conductive carbon black, carbon nanotubes (CNTs), or a conductive polymer such as polyaniline, polyethylenedioxythiophene, polypyrrole, polythiopene, poly(p-phenylene), polyacetylene, poly(p-phenylenevinylene), polythienylenevinylene, polyisothianaphthene, poly(p-phenylene sulfide), and mixtures thereof. Particularly useful is poly-3,4-ethylenedioxythiophene/polystyrenesulfonate (PEDOT/PSS).

The antistatic layer 150 may further include a surfactant, for example, a cationic surfactant such as trimethylammonium ethoxide, trimethylammonium butoxide, trimethylammonium pentoxide, trimethylammonium p-chloropentoxide, trimethylammonium lauryl oxide, alkyltrimethylammonium chloride, dialkylmethylammonium chloride or benzalkonium chloride, an anionic surfactant such as (3-lauramidopropyl) trimethylammonium methylsulfate, carboxylic acid, sulfuric acid ester, sulfonate or phosphoric acid ester, an amphoteric surfactant such as alkyldimethylaminoacetic acid betaine, alkylamidedimethylaminoacetic acid betaine or 2-alkyl-N-carboxy-N-hydroxyimidazolinium betaine, a nonionic surfactant such as polyoxyethylene, polyalcoholic ester or ethyleneoxide/propyleneoxide block copolymer, a natural surfactant such as recitin, a polymer surfactant, or mixtures thereof.

The antistatic layer 150 may include a conductive material and a surfactant so that the sheet surface thereof is maintained at 10⁴˜10¹⁰Ω/□. In the case when the sheet resistance falls in the range of 10⁴˜10¹⁰Ω/□, the antistatic layer 150 blocks the separation of the electric double layer and thus prevents the generation of static electricity. If the sheet resistance is lower than 10⁴Ω/□, the antistatic layer 150 functions to block the generation of electromagnetic waves from the display 160 rather than to prevent static electricity. In contrast, if the sheet resistance is higher than 10¹⁰Ω/□, the antistatic layer acts like a nonconductor and for that reason cannot perform the function of preventing static electricity.

As the antistatic layer 150 is formed at the outermost layer of the touch screen 100a, static electricity is prevented and impurities may not be attached to the first transparent substrate 111. Furthermore, impurities do not remain on the first transparent substrate 111, and thus the user may see the clearer image of the display 160, and damage such as scratches to the first transparent substrate 111 due to impurities may be prevented.

In order to enhance adhesion between the antistatic layer 150 and the first transparent substrate 111, the other surface of the first transparent substrate 111 may be subjected to high frequency treatment or primer treatment.

The display 160 may be adhered to the other surface of the second transparent substrate 112 by means of the second adhesive layer 161a.

The display 160 allows a user to see an image, and may include for example a liquid crystal display (LCD), a plasma display panel (PDP), an electroluminescence (EL) element or a cathode ray tube (CRT).

The second adhesive layer 161a is used to adhere the display 160 to the other surface of the second transparent substrate 112. In the present embodiment, the second adhesive layer may be formed at the outer periphery of the display 160. Specifically, in the case where the second adhesive layer 161a is formed at the outer periphery of the display 160, even when the display 160 and the second transparent substrate 112 are adhered together in a dislocated state, the separation and adhesion thereof are easy. Also, because foam is not formed between the display 160 and the second transparent substrate 112, the display 160 may appear clearer. The second adhesive layer 161a, which is formed at the outer periphery of the display 160, may be DAT.

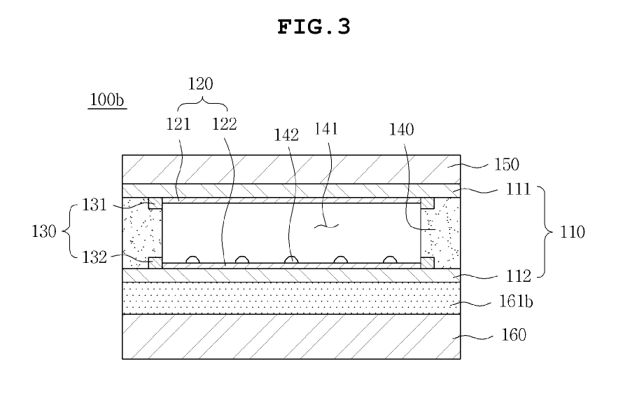

FIG. 3 is a cross-sectional view showing a touch screen 100b according to a second embodiment of the present invention. With reference to this drawing, the touch screen 100b according to the present embodiment is described below.

As shown in FIG. 3, the touch screen 100b includes a transparent substrate 110, transparent electrodes 120, electrodes 130, a first adhesive layer 140, an antistatic layer 150, a second adhesive layer 161b and a display 160. The other constituents, except for the second adhesive layer 161b, are the same as in the first embodiment, and the description thereof is omitted.

The second adhesive layer 161b may be formed on the entire surface of the display 160 which is adhered to the other surface of the second transparent substrate 112, unlike the first embodiment.

In the case where the second adhesive layer 161b is formed on the entire surface of the display 160, an air layer is not present between the other surface of the second transparent substrate 112 and the display 160, thus preventing the distortion of an image. The second adhesive layer 161b which is formed on the entire surface of the display 160 may be made of a transparent material, and may include for example an optical clear adhesive (OCA). Examples of the OCA may include silicone, polyurethane, PVC, acryl, or mixtures thereof.

As described hereinbefore, the present invention provides a touch screen. According to the present invention, the touch screen is advantageous because an antistatic layer is formed on the surface of a first transparent substrate, thus preventing static electricity, so that attachment of impurities and so on is prevented, thereby ensuring the transparency of the touch screen.

Also, according to the present invention, as the attachment of impurities and so on is prevented, damage, such as scratches, to the first transparent substrate can be prevented.

Also, according to the present invention, the sheet resistance of the antistatic layer is maintained at 10⁴˜10¹⁰Ω/□, thus maximizing antistatic effects.

Also, according to the present invention, the touch screen is adhered to the outer periphery of the display using DAT, thus ensuring the transparency of the touch screen. Furthermore, it is easy to correct the touch screen and the display which have been adhered together in a dislocated state.

Also, according to the present invention, the touch screen is adhered to the entire surface of the display using OCA, whereby an air layer is not formed between the touch screen and the display, thus preventing the distortion of the display.

Although the embodiments of the present invention regarding the touch screen have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A touch screen, comprising:
a first transparent substrate having a first transparent electrode formed on one surface thereof;
a second transparent substrate formed to face the first transparent substrate and having a second transparent electrode formed on one surface thereof;
a first adhesive layer formed at an outer periphery between one surface of the first transparent substrate and one surface of the second transparent substrate; and
an antistatic layer formed on the other surface of the first transparent substrate so that a touch input is applied thereto and including a conductive material.

2. The touch screen as set forth in claim 1, wherein the conductive material is sodium alkylphosphate, conductive carbon black, carbon nanotubes, or a conductive polymer.

3. The touch screen as set forth in claim 1, wherein the antistatic layer further includes a surfactant.

4. The touch screen as set forth in claim 1, wherein the antistatic layer has a sheet resistance of 10⁴˜10¹⁰Ω/□.

5. The touch screen as set forth in claim 1, further comprising a spacer formed inside between one surface of the first transparent substrate and one surface of the second transparent substrate.

6. The touch screen as set forth in claim 1, further comprising a display adhered to the other surface of the second transparent substrate using a second adhesive layer.

7. The touch screen as set forth in claim 1, wherein the second adhesive layer is double-sided adhesive tape formed at an outer periphery of the display.

8. The touch screen as set forth in claim 1, wherein the second adhesive layer is an optical clear adhesive formed on an entire surface of the display.

9. The touch screen as set forth in claim 8, wherein the second adhesive layer is silicone, polyurethane, PVC, acryl, or a mixture thereof.

10. The touch screen as set forth in claim 1, further comprising:
a first electrode formed on one surface of the first transparent substrate and connected to the first transparent electrode so as to apply voltage; and
a second electrode formed on one surface of the second transparent substrate and connected to the second transparent electrode so as to apply voltage.
